(19) United States
(12) Patent Application Publication
(10) Pub. No.: US 2005/0078301 A1
(43) Pub. Date: Apr. 14, 2005

(54) Method and apparatus for controlling optical signal power

(76) Inventor: Josef Beller, Tubingen (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/500,201

(22) PCT Filed: Jan. 16, 2002
(86) PCT No.: PCT/EP02/00357

(51) Int. Cl. G01N 21/00

(52) U.S. Cl. 356/73.1

(57) ABSTRACT

For providing an optical measuring signal to an optical component to be measured, the spectral density of the optical signal is broadened until relevant non-linear effects in the optical component occur, at most, by combining a plurality of initial optical signals to create the optical signal.

### BACKGROUND OF THE INVENTION

The present invention relates to providing an optical measuring signal to an optical component (10) to be measured.

When performing optical measurement methods or using optical measurement equipment, e.g. OTDRs, high power probing signals are desirable since the response signals from a device under test are proportional to the level of the stimulus signal. However, if the device under test is for example a fiber, then it is possible that non-linear effects in the fiber limit the maximum power level of the optical probing signals depending on fiber and signal properties. Such adverse effects of high power levels of the optical probing signal can be 4-wave mixing, cross-modulation, Raman scattering, or Brillouin scattering.

A state-of-the-art light source used in optical test equipment is for example a semi-conductor laser diode that exhibits a narrow optical spectrum. The demand for higher optical power can't be simply satisfied with a stronger laser diode because such a device is most likely not available if one is already working with high powered devices and because non-linear effects in fibers start to arise.

UK-A-2359684 discloses a reduction of stimulated Brillouin backscattering in optical transmission systems by broadening the frequency spectrum of transmitted signals utilizing the non-linear effects of self phase modulation or cross-phase modulation to counteract the Brillouin scattering. Modifying the spectral characteristics of optical signals is further known e.g. from EP-A-767395.

### SUMMARY OF THE INVENTION

Therefore, it is an object of the invention to provide improved intensification of an optical signal power. The object is solved by the independent claims. Other preferred embodiments are shown by the dependent claims.

In the context of the present invention the term relevant non-linear effects can be defined, e.g. as the loss of the optical power to frequencies newly generated by the non-linear effects.

An advantage of embodiments of the present invention is the possibility to use high-power probing signals having a higher maximum power level without showing non-linear effects, compared to the high-power probing signals known from the prior art. This possibility is enabled by the present invention since the invention increases the maximum power level of an optical probing signal by broadening the spectral density of the signal. The amount of the broadening, i.e. the spectral distribution and spectral width of the probing signal that can be tolerated depends on the type of measurement the probing signals are used for.

In a preferred embodiment of the invention the broadening of the spectral density of the optical signal is performed by using at least two initial optical signals to create the optical signal, the initial optical signals having different center wavelengths. This embodiment implements the invention in an easy way. In the respective apparatus of the invention it is preferred to combine two or more laser diodes with a preferably low-loss combiner to produce a high-power output signal with a spectral distribution that can be preferably set by proper selection of the laser diodes. The individual laser diodes have preferably approximately the same optical power. More preferably, the spacing of the center wavelengths of each laser diode is not equal between at least two of the center wavelengths.

In order to enhance the effect of the invention, it is preferred to use five to ten laser diodes within a total spectral width of approximately 5 to 20 nanometers. This can preferably be done by using an N-port combiner which preferably shows coupling efficiencies C that are greater than 1/N and are preferably as close as possible to 1. When using such a combiner the total output power increases considerably and the total output Pₜₒₜ can reach Pₜₒₜ=N×P₀×C.

It is clear that the invention can be partly embodied or supported by one or more suitable software programs, which can be stored on or otherwise provided by any kind of data carrier, and which might be executed in or by any suitable data processing unit.

### BRIEF DESCRIPTION OF THE DRAWINGS

Other objects and many of the attendant advantages of the present invention will be readily appreciated and become better understood by reference to the following detailed description when considering in connection with the accompanied drawings. The components in the drawings are not necessarily to scale, emphasis instead being placed upon clearly illustrating the principles of the present invention. Features that are substantially or functionally equal or similar will be referred to with the same reference sign(s).

FIG. 1a shows an example of a laser diode of the prior art together with a optical fiber connected to the laser diode;

FIG. 1b shows an optical spectrum emitted by the laser diode of FIG. 1a;

FIG. 2a laser diodes combined according to an embodiment of the present invention; and

FIG. 2b shows a combined spectrum generated by the laser diodes of FIG. 2a.

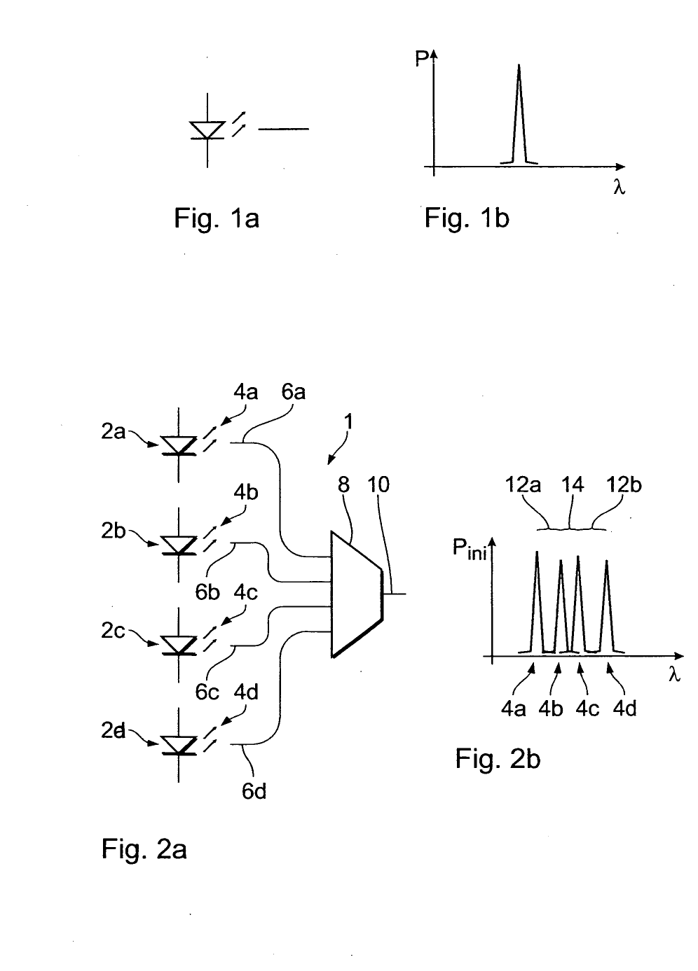

### DETAILED DESCRIPTION OF THE INVENTION

Referring now in greater detail to the drawings, FIG. 2a shows a schematic illustration of an embodiment 1 of an apparatus according to the present invention. Embodiment 1 comprises as laser sources four laser diodes 2a, 2b, 2c and 2d. The laser diodes 2a, 2b, 2c,2d emit initial optical signals 4a, 4b, 4c, 4d, respectively, into four optical fibers 6a, 6b, 6c, 6d, respectively. All laser diodes 2a, 2b, 2c, 2d emit approximately the same optical power.

The four initial optical signals 4a, 4b, 4c, 4d in the optical fiber 6a, 6b, 6c, 6d are combined with the help of a low-loss combiner 8 to an optical signal 10.

Combining the four laser diodes 2a, 2b, 2c, 2d with the combiner 8 produces the optical signal 10 with a high output power and with a spectral distribution that can be set by selection of the center wavelength of the initial optical signals 4a, 4b, 4c, 4d of the laser diodes 2a, 2b, 2c, 2d.

As shown in FIG. 2b all initial optical signals 4a, 4b, 4c, 4d have approximately the same initial optical power Pᵢₙᵢ. However, the spacing 12a between the center wavelength λ of the initial optical signals 4a and 4b preferably is not the same as the spacing 12b between the center wavelength λ of the initial optical signals 4c and 4d and is different, e.g. bigger than the spacing 14 between the center wavelength λ of the initial optical signals 4b and 4c.

The 4-port combiner 8 shows a coupling efficiency C that is greater than ¼ and is close to 1. The total output power Pₜₒₜ can be calculated as follows: Pₜₒₜ=4×P₀×C, P₀ being the power of a single laser diode 2a, 2b, 2c, 2d, assuming all diodes 2a, 2b, 2c, 2d emit the same optical power. With a proper selection of the wavelength λ of the individual laser diode 2a, 2b, 2c, 2d, the resulting spectrum according to FIG. 2b can minimize non-linear effects in the optical fiber 10 yielding a much higher response signal in an optical measurement, e.g. an OTDR measurement, and thus a gain in a signal to noise ratio, in measurement speed, or in measurement accuracy etc. In embodiment 1 the added spacings 12a, 14 and 12b between the center wavelength of initial optical signal 4a and initial optical signal 4d amount to approximately 5 nm. In embodiment 1 the center wavelengths of the initial optical signals 4a, 4b, 4c, 4d have been chosen to be 1310 nm, 1312 nm, 1313 nm, 1315 nm, respectively.

1. A method for providing an optical measuring signal to an optical component to be measured, comprising the step of:
broadening the spectral density of the optical signal until relevant non-linear effects in the optical component occur, at most, by combining a plurality of initial optical signals to create the optical signal.

2. The method of claim 1, wherein the initial optical signals have different center wavelengths.

3. The method of the claims 1, further comprising the steps of:
using between about 4 to 11 initial optical signals.

4. The method of claim 1, further comprising the step of:
adjusting a spacing between the center wavelengths of any two of the initial optical signals to be not equal to each other.

5. The method of claim 1, further comprising the step of:
adjusting the initial optical signals to have approximately the same optical power.

6. The method of claim 1, further comprising the step of:
increasing the power of the optical signal until relevant non-linear effects in the optical component occur, at most, by increasing the power of the initial optical signals until relevant non-linear effects in the optical component occur, at most.

7. The method of claim 1, further comprising the step of:
adjusting the spacing between the center wavelength of the initial optical signal having the smallest center wavelength and the initial optical signal having the biggest center wavelength to be not greater than about 20 nanometer.

8. The method of claim 1, further comprising the steps of:
combining the initial optical signals by coupling them together, the coupling having coupling efficiencies C>1/N, preferably approximately 1, if Pₜₒₜ=N×Pᵢₙᵢ×C, Pₜₒₜ being the total output of the combined initial optical signals, Pᵢₙᵢ being the output of a single initial optical signal, N being the number of the initial optical signals.

9. A software program or product, preferably stored on a data carrier, for executing the method of claim 1, when run on a data processing system such as a computer.

10. A method for performing an optical time domain reflectometer—OTDR—measurement, comprising the steps of:
providing an optical measuring signal to an optical component to be measured by broadening the spectral density of the optical signal until relevant non-linear effects in the optical component occur, at most, by combining a plurality of initial optical signals to create the optical signal, and
detecting a response signal in response to the optical measuring signal provided to an optical component.

11. An apparatus for providing an optical signal to an optical component, comprising:
a broadening device adapted for broadening the spectral density of the optical signal until relevant non-linear effects in the optical component occur, at most, by combining a plurality of initial optical signals to create the optical signal.

12. The apparatus of claim 11, further comprising:
at least two laser sources to provide at least two initial optical signals to create the optical signal, the initial optical signals having different center wavelengths.

13. The apparatus of claim 11, further comprising:
at least one combiner to combine the initial optical signals to the optical signal.

14. The apparatus of claim 11, further comprising:
a combiner having coupling efficiencies C>1/N, preferably approximately 1, if Pₜₒₜ=N×Pᵢₙᵢ×C, Pₜₒₜ being the total output of the combined initial optical signals, Pᵢₙᵢ being the output of a single initial optical signal, N being the number of the initial optical signals.

15. An optical time domain reflectometer—OTDR—, comprising:
an apparatus, adapted for providing an optical measuring signal to an optical component to be measured, comprising a broadening device adapted for broadening the spectral density of the optical signal until relevant non-linear effects in the optical component occur, at most, by combining a plurality of initial optical signals to create the optical signal, and
a detector adapted for detecting a response signal in response to the optical measuring signal provided to an optical component.
